(19) United States
(12) Patent Application Publication
(10) Pub. No.: US 2008/0139172 A1
(43) Pub. Date: Jun. 12, 2008

(54) System and method for conducting a subscriber communications equipment lease and usage service program

(75) Inventor: Bennett P. Gamel, Overland Park, KS (US)

Correspondence Address: PATTON BOGGS, LLP, 2001 ROSS AVENUE, SUITE 3000, DALLAS, TX, 75201, US

(73) Assignee: EMBARQ HOLDINGS COMPANY, LLC

(21) Appl. No.: 11/634,610

(22) Filed: Dec. 6, 2006

(51) Int. Cl. H04M 11/00

(52) U.S. Cl. 455/406

(57) ABSTRACT

A system and method for providing a telecommunications lease and usage service program. A method may include billing a subscriber of a telecommunications carrier for leasing communications equipment, and billing the subscriber usage charges for use of the leased communications equipment. The communications equipment may be a mobile telephone. The billing may be performed on a single invoice.

### BACKGROUND OF THE INVENTION

Technology for telecommunications has significantly improved over the past decade. Sound quality, connection reliability, and cost of telecommunications services have all improved for subscribers. In addition, telecommunications equipment, such as mobile telephones, has developed to include features, such as text messaging, cameras, and contact databases, that have been embraced by consumers. Further, the carriers have developed a number of services, including video on demand (VOD) and music downloading.

Because communications equipment and services have improved at such a rapid rate, consumers who purchase the communications equipment and subscribe to particular telecommunications services find their equipment and services to become outdated in relatively short periods of time. As the rate of the telecommunications technology has increased, consumers have become more dissatisfied with their communications equipment and services. More particularly, recent consumer surveys suggest that more than one-third of wireless customers in the U.S. are dissatisfied with their personal wireless device. Consumers are becoming increasingly concerned and uncertain about purchasing communications equipment, such as mobile telephones, wireless handheld devices, and other communications devices, at the point of sale for fear that the equipment will become outdated in a short period of time. Further, consumers are becoming increasingly dissatisfied with the ability for telecommunications carriers to help them repair or replace broken communications devices quickly and conveniently, in part, due to the communications equipment models not being produced or supported after just a few months. Many consumers find that warranty terms being offered are insufficient for the price they pay to purchase the communications equipment.

Despite the concerns and dissatisfaction of consumers with their communications devices and telecommunications services, consumers find that life with unsatisfactory telecommunications devices and services is better than the alternative. To attract consumers and encourage them to become subscribers, carriers have developed and offered many different subscriber equipment and usage services programs. Many of these programs have focused on financial incentives, such as offering free mobile telephones and crediting new subscribers to enter into a contract (e.g., one or two years), with a carrier. At the end of a subscriber's contract, the carrier typically offers additional credit to the subscriber to purchase or receive a free new mobile telephone in order to encourage the subscriber to enter into another service contract.

While the programs to encourage new and current subscribers to enter service contracts with telecommunications carriers, these programs tend to be detrimental to either the subscribers or the telecommunications carriers. In the case of free telephones being offered, these telephones are generally of lower quality and lead to dissatisfactions with the subscriber. In the case of credits being provided, the cost of the mobile telephones tends to be expensive for subscribers due to being based on retail prices and increases the cost per customer for the telecommunications carriers. In addition, while these programs generally save consumers money, the programs do little to alleviate the fears and concerns of consumers of purchasing communications devices and services that become antiquated during the period of a service contract given the rate of technology.

### SUMMARY

To overcome the problem with conventional communications equipment (e.g., mobile telephone) and service programs, a combination equipment lease and usage service program may be provided to customers of a telecommunications carrier. The lease and service program may have a short enough term to reduce fear and concern about selecting inadequate communications equipment by potential and existing subscribers of the carrier that subscribers are more willing to become and remain subscribers of the carrier. The lease and service plan allows subscribers to pay a low monthly equipment charge fee to enable subscribers, even of modest means, to use equipment that would otherwise be unattainable due to up-front costs under conventional equipment purchase programs with discounts. Under the lease and service program, subscribers may exchange the communications equipment in relatively short periods of time, such as one year or less, and receive complimentary equipment that is newer to avoid having outdated equipment. The carrier may refurbish the equipment and re-sell to secondary markets. Depending on the age of the exchanged equipment, the cost, if any, to the carrier to provide the equipment to its subscribers is minimal or the carrier makes a profit.

In one embodiment, a system and method may provide for a lease and usage service program. A method may include billing a subscriber of a telecommunications carrier for leasing communications equipment, and billing the subscriber usage charges for use of the leased communications equipment. The billing may be performed on a single invoice.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an exemplary business relationship between a telecommunications carrier and subscribers;

FIG. 2 is an illustration of an exemplary system for managing and providing a telecommunications equipment lease and usage service contract; and

FIG. 3 is a block diagram of an exemplary process for providing telecommunications services to subscribers of a telecommunications carrier.

### DETAILED DESCRIPTION OF THE DRAWINGS

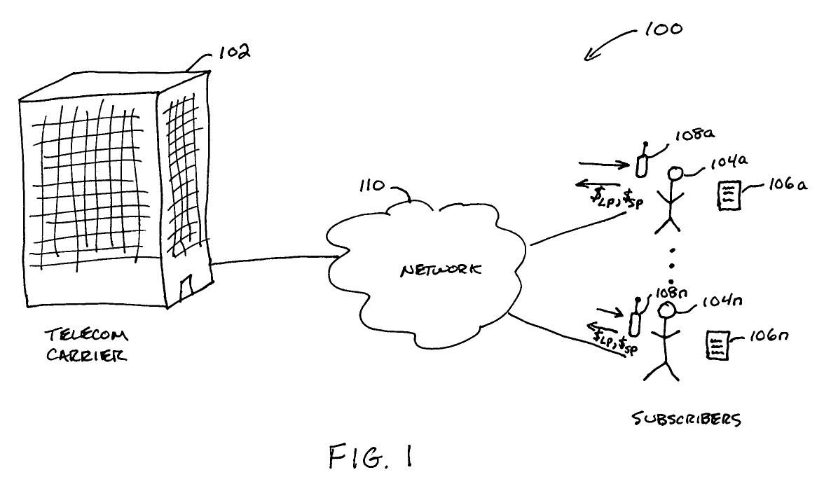

FIG. 1 is an illustration of an exemplary business relationship 100 between a telecommunications carrier 102 and subscribers 104a-104n (collectively 104). The carrier 102 may attract subscribers 104 by offering a lease and usage service program (the “program”) in accordance with the principles of the present invention. In offering the program, lease and usage service agreements 106a-106n (collectively 106) may be provided by the carrier 102 to the subscribers 106 that set forth the lease and usage service terms. Alternatively, the lease and usage service terms may be provided on separate agreements. Although, in one embodiment, the service provider may provide such agreement(s) for the program, it should be understood that affiliates of the carrier 102 may alternatively form lease and usage service agreements with subscribers, thereby sharing in both a portion of revenue and liability with the carrier 102.

The carrier 102 may offer communications equipment under a lease. The lease terms may be structured in such a way as to have no or low up-front payment and have a regular payment schedule, such as a monthly payment schedule. The lease terms may further be structured to be short term. For example, the term of the lease may be one year or shorter (e.g., six or nine months) so that the communications equipment has secondary market re-sale value at the end of the lease term. By having a short lease term, the subscribers 104 are alleviated from the concern that their equipment will become outdated as technology advances and the carrier 102 will be confident that a secondary market will exist for equipment exchanged by the subscribers 104.

In consideration for a subscriber 104a entering into a lease and service contract 106a, the carrier 102 provides the subscriber 104a with communications equipment 108a and, in consideration for receiving the communications equipment 108a and usage services, the subscriber 104a pays the carrier 102 a lease payment $_{LP} and service payment $_{SP} to access a network 110 maintained and managed by the carrier. The equipment 108a-108n (collectively 108) may be a mobile telephone, cordless telephone, modem, computing device, handheld wireless device (e.g., pager or Blackberry®), or other communications equipment

The durations (i.e., terms) of the lease and usage service contract 106a may be the same or different. For example, the service agreement may have a two year term and the lease of the communications equipment 108a may be six months so that the subscriber 104a may, optionally, exchange the equipment 108a up to four times during the term of the service agreement. Longer and shorter term leases may also be provided to subscribers. By providing such lease and usage service agreements, the subscribers 104a may benefit by having communications equipment that is current with technology and the carrier 102 may attract subscribers and sell them on usage service contracts.

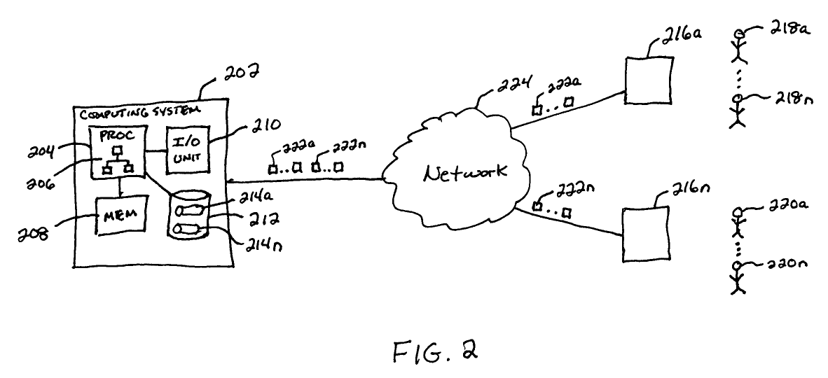

FIG. 2 is an illustration of an exemplary system 200 for managing and providing a telecommunications equipment lease and usage service contract. The system includes a computing system 202 having a processing unit 204 that executes software 206. The processing unit 204 may further be in communication with a memory 208 for storing data and software 206 during execution, an input/output (I/O) unit 210 for communicating with devices remote from the computing system 202, and a storage unit 212 that stores one or more databases 214a-214n (collectively 214). The databases 214 may be utilized to store information associated with subscribers of a telecommunications carrier that offers the lease and service contract program in accordance with the principles of the present invention. It should be understood that the storage unit 212 and databases 214 may be located within the computing system 202 or remotely located from the computing system 202, but that the processing unit 204, which may include one or more processors, is in communication with the databases 214. The databases 214 may be managed by a commercial database program, such as Microsoft Access®, or a proprietary database program produced and managed by the telecommunications carrier.

The telecommunications carrier may include a number of rate centers 216a-216n (collectively 216), where each of the rate centers 216 have subscribers 218a-218n (collectively 218) and 220a-220n (collectively 220) with telephone numbers associated therewith. In operation, the rate centers 216 may collect subscriber information when new subscribers enter into lease and usage service agreements and enter the information into local databases (not shown). The information may be communicated from the local databases to the computing system 202 in data packets 222a-222n via a network 224. The network 224 may be the Internet or an intranet of the telecommunications carrier. Alternatively, the rate centers 216 may enter the information directly into the databases 214 via a graphical user interface (not shown) via the network 224. It should be understood that rather than the rate centers performing the role of collecting the subscriber information, the other entities of the telecommunications carrier or affiliates thereof may collect the subscriber information. By collecting the subscriber information, the telecommunications carrier may be able to centrally manage the lease and usage service program.

TABLES I(a)-I(c) (collectively TABLE I) is an exemplary database of subscriber information associated with a lease and usage service program. The database may be managed by the computing system 202 and stored on the storage unit 212 of FIG. 2. The database, as shown in TABLE I(a), may include information associated with subscribers, equipment provided to respective subscribers, lease agreement, usage service agreement, and equipment return. The subscriber information may include subscriber ID and name. Other subscriber information, such as address, telephone number, demographic information (e.g., age, race, income, etc.), may also be stored in the database.

The equipment information may include equipment type, model, ID (e.g., serial number), date of manufacture, and value. The value may be a wholesale price or the price charged to the telecommunications carrier by the equipment manufacturer. The date of manufacture and value may be used upon return of the equipment to determine the remaining value of the communications equipment when the subscriber exchanges the equipment. For example, subscriber having ID 1PB5790 has an LG mobile telephone having model LG125 that was manufactured on Dec. 15, 2004. The value of the telephone was $112.00 to the telecommunications carrier, so this value is used to determine the remaining value of the telephone upon return by the subscriber.

TABLE I(a)
Subscriber Lease Information

| | | Equipment Info. | | | | |
|---|---|---|---|---|---|---|
| Subscriber Info. | | | | | Date of | |
| ID | Name | Manufacturer/Type | Model | ID | Manuf. | Value |
| 1PB5790 | Greg Smith | LG/Mobile Phone | LG125 | 90832D4FJ | Dec. 15, 2004 | $112.00 |
| 949M0U4 | Michael Roth | RIM/Blackberry | 8700c | 4T7274AE | Jan. 05, 2005 | $240.00 |
| 3D4E79 | Ronna Cross | Sanyo/Mobile Phone | 2400 | 73742BN7 | Oct. 20, 2006 | $75.00 |

The database, as shown in TABLE I(b), may include lease agreement information, including lease number, monthly recurring charges (MRC), start date of the lease, and term of the lease. The term of the lease defines the minimum amount of time that the subscriber leases the communications equipment. The shorter the lease term, the more remaining value that the equipment will have at the end of the term of the lease. As understood in the art, equipment that is six months old will have approximately 60% of its original value, equipment that is 12 months old will have approximately 30% of its original value, and equipment that is 18 months old will have 0% of its original value. Such depreciation of equipment value is generally linear, but, depending on the equipment type, market factors, or other value adjusting reasons, other depreciation models may be utilized. By setting lease terms relatively short (e.g., one year or shorter), the carrier may charge a relatively low lease charge because a portion of the value of the equipment may be recovered through refurbishing and re-selling the equipment to secondary markets. The monthly charges for leasing the equipment ray be based on a number of factors, including equipment starting value and length of lease.

In addition to the subscriber and lease agreement information, other information, including warranty terms and insurance may be stored in the database, as shown in TABLE I(b). The warranty information may include the number of days that a subscriber has for a particular communications equipment and other warranty information (not shown), including terms of the warranty. An indicator as to whether each subscriber has selected and paid for insurance on the communications equipment being leased may be included in the database. As with the warranty information, additional terms (not shown) indicative of the insurance program (e.g., insurance carrier) may be included in the database.

TABLE I(b)
Subscriber Lease Agreement Information

| | Lease Agreement Info | | | | | |
|---|---|---|---|---|---|---|
| Subscriber | | Charges | | | Other Info | |
| Info | | (Month- | | | | Insur- |
| ID | No. | ly) | Start Date | Term | Warranty | ance |
| 1PB3790 | 07273 | $4.49 | Jan. 30, 2005 | 9 mo. | 90 days | No |
| 949M0U4 | 07274 | $14.49 | Feb. 21, 2005 | 6 mo. | 180 days | Yes |
| 3D4E79 | 07275 | $6.99 | Dec. 02, 2006 | 6 mo. | 90 days | Yes |

The database, as shown in TABLE I(c), may include usage service agreement information including usage service agreement number, monthly charges, start date, and term. As provided, each of the usage service terms are 2 years, which is longer than the relatively short term lease agreement terms of six and nine months. It should be understood that the length of the lease may be any length, short than and up to the full usage service term. In the case of the lease term being six months, the subscriber may receive four different pieces of equipment over the term of the service agreement. Being able to receive four different pieces of equipment over the term of the service agreement gives confidence to subscribers that their equipment will not go out of style, become outdated technology, or have a higher chance of becoming damaged over the term of the service agreement, as are the cases of traditional equipment purchase programs.

Also shown in TABLE I(c) is returned or exchanged equipment information. The information includes communication equipment return date and equipment remaining value based on the age and original value of the equipment. The software 206 (FIG. 2) executed by the processing unit 204 may verify that the equipment is returned in working condition after the term of the lease and determine the value of the equipment. Although not shown in the database, information associated with new equipment selected by the subscriber in exchange for the returned equipment may be stored. The new equipment may be the same value as the exchanged equipment to extend the lease agreement. Equipment that is of higher or lower value may necessitate a new lease agreement rather a simple extension or renewal of an existing lease agreement. Alternatively, a new lease agreement may be made with each subscriber for each equipment exchange during the term of the usage service agreement. It should be understood that subscribers may renew existing or execute new lease and service agreements (i) in person at a retail facility, (i) via mail, or (ii) via an online interface.

TABLE I(c)
Subscriber Usage Service Information

| | | | | | Exchanged Equipment Info | |
|---|---|---|---|---|---|---|
| Subscriber | Usage Service Agreement Info | | | | Equip. | Equip. |
| Info | | Charges | | | Return | Remaining |
| ID | No. | (Monthly) | Start Date | Term | Date | Value |
| 1PB3790 | 107425 | $48.50 | Nov. 30, 2006 | 2 yrs. | Oct. 03, 2005 | $33.60 |
| 949M0U4 | 107426 | $15.00 | Dec. 01, 2006 | 2 yrs. | Sep. 07, 2005 | $144.00 |
| 3D4E79 | 107427 | $36.00 | Dec. 02, 2006 | 2 yrs. | — | — |

The exchanged equipment information may be aggregated by the software 206 (FIG. 2) to make available to secondary markets, such as a secondary telecommunication market. The information may be aggregated by performing a search on all communications equipment being of a certain age, brand, model remaining value, or other commonality to enable buyers or sellers in secondary markets to easily identify refurbished communications equipment that can be purchased and sold in bulk.

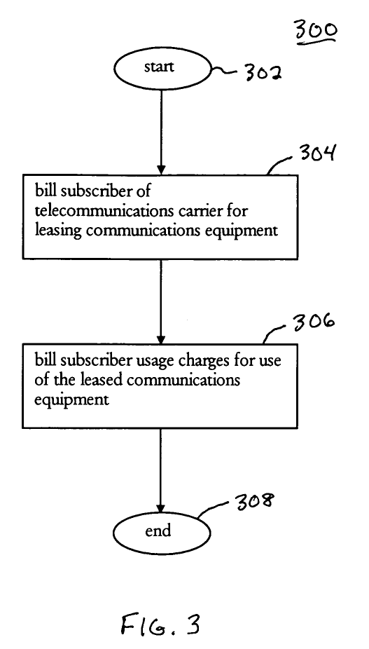

FIG. 3 is a block diagram of an exemplary process 300 for providing telecommunications services to subscribers of a telecommunications carrier. The process 300 starts at step 302. At step 304, a subscriber of a telecommunications carrier is billed for leasing communications equipment. At step 306, the subscriber is billed for usage charges for using the leased communications equipment. In one embodiment, the subscriber is billed on a single invoice for the lease and usage charges. Alternatively, multiple invoices may be generated for the lease and usage charges. The invoices may be produced on paper for mailing or be electronically communicated to the subscriber. The process 300 ends at step 308. By using a lease and usage service agreement, the telecommunications carrier generally increases customer lifetime value (CLV) over conventional post-paid subscription agreements due to subscribers no longer worrying about purchasing communications equipment and having outdated technology that ultimately frustrates the subscribers.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed

1. A method for providing telecommunications services to subscribers of a telecommunications carrier, said method comprising:
billing a subscriber of a telecommunications carrier for leasing communications equipment; and
billing the subscriber usage charges for use of the leased communications equipment.

2. The method according to claim 1, further comprising enabling the subscriber to exchange the leased communications equipment after a predetermined lease term.

3. The method according to claim 2, wherein the lease term is one year or shorter.

4. The method according to claim 2, wherein the lease term is nine months or shorter.

5. The method according to claim 2, wherein the lease term is six months or shorter.

6. The method according to claim 1, wherein the telecommunications equipment is a mobile telephone.

7. The method according to claim 1, further comprising:
exchanging the communications equipment from the subscriber for another communications equipment; and
refurbishing the exchanged communications equipment.

8. The method according to claim 7, further comprising selling the refurbished communications equipment in a secondary telecommunications market.

9. The method according to claim 7, further comprising selling the refurbished communications equipment in bulk in a secondary telecommunications market.

10. The method according to claim 7, further comprising determining that the exchanged communications equipment is in working condition prior to exchanging the communications equipment.

11. The method according to claim 1, further comprising optionally insuring the communications equipment.

12. A system for managing telecommunications services to subscribers of a telecommunications carrier, said system comprising:
a database configured to store information associated with subscribers of a telecommunications carrier, and
a processing unit in communication with said database and executing software configured to:
generate information for billing a subscriber of the telecommunications carrier for leasing communications equipment;
generate information for billing the subscriber usage charges for use of the leased communications equipment; and
prepare an invoice including the billing information for leasing and using the communications equipment.

13. The system according to claim 12, wherein the software is further configured to update the information stored in said database in response to the subscriber exchanging the leased communications equipment after a predetermined lease term.

14. The system according to claim 13, wherein the lease term is one year or shorter.

15. The system according to claim 13, wherein the lease term is nine months or shorter.

16. The system according to claim 13, wherein the lease term is six months or shorter.

17. The system according to claim 12, wherein the telecommunications equipment is a mobile telephone.

18. The system according to claim 12, wherein the software is further configured to update the information stored in the database to include information associated with another communications equipment in response to the subscriber exchanging the communications equipment.

19. The system according to claim 18, wherein the software is further configured to:
determine a refurbished value of the communications equipment based on age; and
store the refurbished value and information associated with the exchanged communications equipment in said database.

20. The system according to claim 19, wherein the software is further configured to:
aggregate the information associated with the exchanged communications equipment; and
generate a report including the aggregated information associated with the exchanged communications equipment.

21. The system according to claim 12, wherein said database is configured to store warranty information associated with the communications equipment.

22. The system according to claim 12, wherein said database is configured to store insurance information for the communications equipment.
